(19) United States
(12) Patent Application Publication
(10) Pub. No.: US 2026/0162483 A1
(43) Pub. Date: Jun. 11, 2026

(54) VENDING MACHINE FOR CHILDREN

(71) Applicant: Kayla R Brown, Orlando, FL (US)

(72) Inventor: Kayla R Brown, Orlando, FL (US)

(21) Appl. No.: 19/178,818

(22) Filed: Apr. 14, 2025

Related U.S. Application Data
(60) Provisional application No. 63/552,893, filed on Feb. 13, 2024.

(51) Int. Cl. G07F 9/00; G07F 9/02; G07F 11/62

(52) U.S. Cl. CPC G07F 9/001; G07F 9/009; G07F 9/026; G07F 11/62

(57) ABSTRACT

A vending machine designed for children that can dispense various snack items. The easy-to-use interface of the vending machine allows children to order snack items from the vending machine. The vending machine may also include a child safety feature in which a child wearable device can be dispensed by the vending machine. The vending machine can track the location of the child wearable device and its distance from the vending machine. Alerts can be issued by the vending machine if a child wearing the child wearable device goes out of a predefined parameter from the vending machine.

### CROSS REFERENCE TO RELATED APPLICATIONS

This application claims priority from a U.S. Provisional Patent Appl. No. 63/552,893, filed on Feb. 13, 2024, which is incorporated herein by reference in its entirety.

### FIELD OF INVENTION

The present invention relates to a vending machine, and more particularly, the present invention relates to a vending machine for children.

### BACKGROUND

Children enjoy a variety of snacks, candies, chocolates, and other treats. Parents often keep these items at home for their children. When going out, like on picnics, parents typically carry snacks with them. However, it is not uncommon to forget snacks when leaving home. Such situations can be troublesome for parents who may have to rush around for snacks, or the desired items might not be available.

Thus, there is a need for an apparatus and method for children that can store and dispense snack items to children.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a vending machine designed exclusively for children.

Another object of the present invention is that the vending machine provides a toy-like experience for children.

Still another object of the present invention is that the vending machine can also provide emotional support to the child.

Yet another object of the present invention is that the different snack items are readily available to the child.

A further object of the present invention is that the vending machine may have flashy lights and bright colors.

Still, a further object of the present invention is that the vending machine provides a quick and accessible solution for obtaining forgotten essentials, reducing stress and delays.

In one aspect, disclosed is a method for dispensing snack items and providing child security, the method comprising dispensing, by a vending machine, a child wearable device; activating, by a vending machine, the child wearable device, wherein the child wearable device is configured to be worn by a child, wherein the child wearable device is coupled to the vending machine through a wireless connection; tracking a distance of the child wearable device from the vending machine; and generating an alert when the child wearable device breaches a predefined perimeter from the vending machine. The method further comprises: dispensing one or more snack items from the vending machine, wherein the vending machine comprises a plurality of compartments for storing snack items and a conveying unit to deliver the snack items to a pickup door of the vending machine. The child wearable device is stored in one or more of the plurality of compartments and dispensed by the conveying unit. The method further comprises implementing an interface for interacting with a user, wherein the user can select a desired snack item and/or the child wearable device through the interface. The child wearable device is a hand band that is configured to be worn on a hand of a child. The method further comprises pairing, by the vending machine, the child wearable device with an external computing device; and transmitting a notification about the child wearable device to the external computing device. The notification is about the child wearable device breaching a predefined perimeter from the vending machine. The dispensing of the child wearable device by the vending machine results in activation of the child wearable device.

In one aspect, disclosed is a vending machine for dispensing snack items for children and providing child security, the vending machine comprising a plurality of compartments; one or more child wearable devices stored in one or more of the plurality of compartments, wherein each of the child wearable device is configured to be activated by the vending machine, wherein the child wearable device is configured to be worn by a child, wherein, upon activation, the child wearable device is configured to be coupled to the vending machine through a wireless connection; and a control unit configured for tracking a distance of the child wearable device from the vending machine and generating an alert when the child wearable device breaches a predefined perimeter from the vending machine. The one or more of the plurality of compartments are configured to store snack items, wherein the vending machine comprises a conveying unit to deliver the snack items to a pickup door of the vending machine. The conveying unit is configured to deliver the child wearable device from the respective compartment to the pickup door. The control unit is configured to implement an interface for interacting with a user, wherein the user can select a desired snack item or the child wearable device through the interface. The child wearable device is a hand band that is configured to be worn on a hand of a child. The control unit is configured for pairing the child wearable device with an external computing device; and transmitting a notification about the child wearable device to the external computing device. The notification is about the child wearable device breaching a predefined perimeter from the vending machine. The dispensing of the child wearable device by the vending machine results in activation of the child wearable device.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram showing an overview of the vending machine, according to an exemplary embodiment of the present invention.

FIG. 2 shows an overview of a child wearing device, according to an exemplary embodiment of the present invention.

FIG. 3 is a flowchart illustrating a process, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention, since the scope of the invention will be best defined by the allowed claims of any resulting patent.

Disclosed is a vending machine designed for kids with flashy lights, bright colors, and easy-to-use buttons and interface. The disclosed vending machine for children may provide a toy-like experience that may be satisfying to children and help with emotional support. Parents no longer have to carry snack items with them. Also, the vending machine can store different snack items in an organized manner, such that children can easily recognize and order the desired snack items.

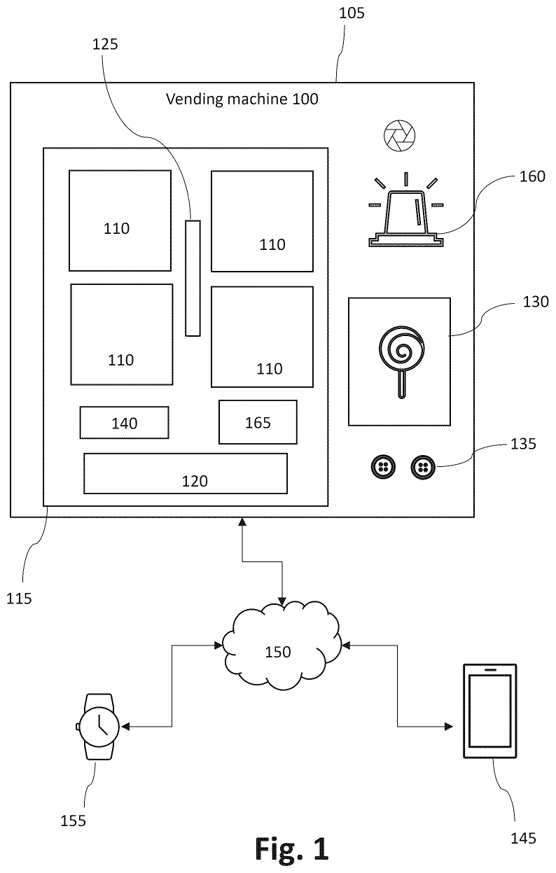

Referring to FIG. 1, which is a block diagram showing the architecture of the disclosed vending machine 100. The vending machine may include various compartments 110 within a housing 105 for storing the snack items in an orderly manner. The different compartments 110 may be for different product categories, such as toys, snacks, wipes, pull-ups, and anti-lock bands. The different compartments may keep the snack items organized and clearly labeled. The housing may have a door 115 to provide access to the compartments 110. The housing 105 may also have a low pickup door 120 through which a snack item can be picked up. The vending machine 100 may also include a conveyor or a drop-down system 125 for picking the selected snack item from the respective compartment and delivering the same to the low pickup door.

The vending machine may also include an interface for interacting with a user. The user can select a desired snack item through the interface, and the conveyor or drop-down system can pick the selected snack item from the respective compartment and drop the same to the low pickup door for the user to collect. The interface may include a display 130 that can present different snack items that are available in the vending machine. The interface may also include one or more input means 135 to receive a selection of a snack item from a user. The input means may be in the form of a touch interface, hard buttons, and the like. The touch interface may be coupled to the display. The display may be optional, and the buttons may be provided as the interface with images of respective snack items.

The vending machine may be made from durable and child-safe material. Preferably, the vending machine may be made from lightweight materials, such as aluminum and plastic. This may allow the vending machine to be lightweight and can be easily carried. Moreover, the housing may be made from strong and durable material with round edges. Any sharp edges or corners may be avoided to prevent injury.

The disclosed vending machine may also include a control unit 140, the control unit may include a memory. The control unit may control different aspects of the vending machine, such as interface, display, receiving selections of snack items, dispensing snack items, connection to external devices, and inventory control. The control unit may be configured to manage the inventory of the snack items in the vending machine. The control unit may track the loading of the vending machine with snack items and the dispensing of the snack items from the vending machine. The control unit may be connected to an external computing device, such as a smartphone. The user, through the external computing device, can view the status of inventory anytime. Also, the control unit can send a notification to the operator for restocking of any snack item. The control unit may connect to the external device 145 through any suitable wired or wireless connection 150. For example, the control unit may connect through Bluetooth®, Wi-Fi, cellular internet, and the like.

In certain implementations, the vending machine may also include an anti-lock safety feature that may help ensure that children remain within a safe distance in crowded environments, enhancing overall travel security. The vending machine may also stock and dispense anti-lock bands 155. Children can wear these bands to track their position relative to the vending machine. It is to be noted that the vending machine may include any suitable child wearable device 200, such as bands, necklaces, tags, and the like. The child wearable device 200 can be worn on the hand, legs, neck, and the like by the children. These child wearable devices can be stored in the vending machine in protective packaging with all the instructions to use the anti-lock safety feature.

The vending machine may connect to one or more child wearable devices through wireless connections, such as RFID, Bluetooth®, and GPS tracking. The control unit of the vending machine may track the distance of a child wearable device from the vending machine based on signal strength, i.e., the signal strength of the wireless connection between the vending machine and the child wearable device. It is to be noted that any other suitable method for tracking the distance of the child wearable device from the vending machine may be within the scope of the present invention. For example, GPS-based tracking can be used. The disclosed vending machine may include a suitable alert unit 160, such as a light and sound indicator, to indicate that a particular child wearable device is out of a predefined distance from the vending machine. A unique number of the child wearable device or the name of a child wearing the child wearable device may be displayed on the display of the vending machine with an alert sound. The vending machine may also send a notification of the child breaching the predefined perimeter to an external device. For example, the notification can be sent to a parent on their smartphone as an alert that their child has gone out of the predefined perimeter from the vending machine. The control unit may pair the child wearable device with a smartphone or any other computing device. The instructions to pair the smartphone with the child pair device can be shown by the control unit. For example, a QR code may be displayed on the display of the vending machine, which can be scanned by the smartphone for pairing with the child wearable device.

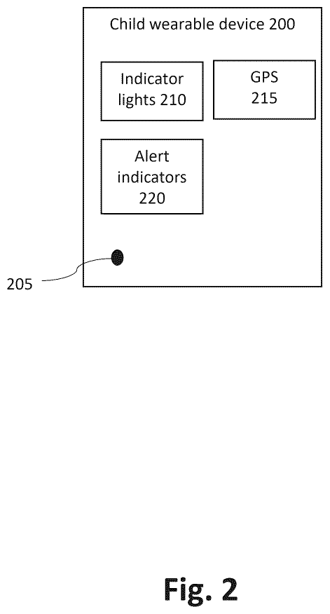

The child wearable device may automatically activate upon dispensing from the disclosed vending machine. Also, there may be an option to manually turn on the child wearable device, for example a hard button 205 may be provided that can be pressed to turn on the child wearable device, as shown in FIG. 2. The child wearable device may include indicator lights 210 to show its status, such as the device is turned on and connected to the vending machine.

In certain implementations, the vending machine may also include a bin 165 to return the child wearable device 200, for example, from a parent. The vending machine may automatically know which child wearable device is returned and can turn it off. The vending machine may also restock the child wearable devices automatically from the bin 165.

In case the child wearable device includes a GPS unit 215, the vending machine may also receive the current location of the child wearable device and send the same to the parent device. Also, the sound alarm 220 on the child wearable device can be advantageous by attracting the attention of nearby people to the child. In certain implementations, one-way or two-way audio communication may also be established between the child wearable device and the vending machine or to the parent's phone through the vending machine. Through the vending machine or the parent's device, audio messages, such as to “come back,” can be broadcast on the child wearable device. Optionally, these audio alerts can be stored in the child wearable device. Instead of sound beeps, said audio messages can be played by the child wearable device.

The disclosed vending machine may be used in bus stops, railways, airports, shopping malls, spas, and the like, in public places. This feature is particularly useful for parents who engage in some activity while the child can freely wander near the parent. For example, in a shopping mall, the child can get desired snack items and also use the disclosed antilocking feature to keep the child safe, while the parent can do shopping.

The disclosed vending machines may also include a billing unit that may receive coins, bills, credit/debit cards, contactless (tap-to-pay), and other forms of payment. The billing unit may be connected to the interface of the vending machine to show the payment details.

The height of the interface and the window to collect the snack items may be at a lower height so that both are easily accessible to children. The vending machine may also incorporate a display for displaying rotating ads or promotions for child-friendly products. The disclosed vending machine may allow children to draw the products from the vending machine themselves. The children can see the products themselves in the vending machine and order the same. Moreover, the colorful scheme and designs on the vending machine make the dispensing process cheerful for the children.

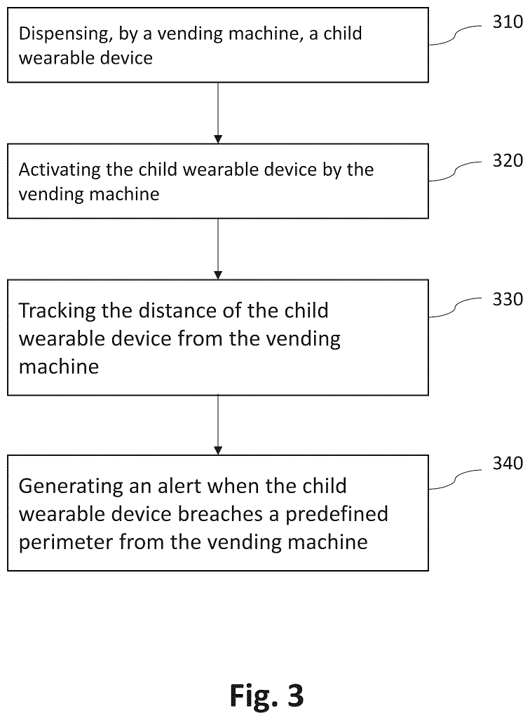

Referring to FIG. 3, which illustrates the steps of the disclosed method for child security by the vending machine. The method includes dispensing, by a vending machine, a child wearable device, at step 310; activating the child wearable device by the vending machine, at step 320; tracking the distance of the child wearable device from the vending machine; and generating an alert when the child wearable device breaches a predefined perimeter from the vending machine.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for dispensing snack items and providing child security, the method comprising:
dispensing, by a vending machine, a child wearable device;
activating, by a vending machine, the child wearable device, wherein the child wearable device is configured to be worn by a child, wherein the child wearable device is coupled to the vending machine through a wireless connection;
tracking a distance of the child wearable device from the vending machine; and
generating an alert when the child wearable device breaches a predefined perimeter from the vending machine.

2. The method of claim 1, wherein the method further comprises:
dispensing one or more snack items from the vending machine, wherein the vending machine comprises a plurality of compartments for storing snack items and a conveying unit to deliver the snack items to a pickup door of the vending machine.

3. The method of claim 2, wherein the child wearable device is stored in one or more of the plurality of compartments and dispensed by the conveying unit.

4. The method of claim 3, wherein the method further comprises:
implementing an interface for interacting with a user, wherein the user can select a desired snack item and/or the child wearable device through the interface.

5. The method of claim 4, wherein the child wearable device is a hand band that is configured to be worn on a hand of a child.

6. The method of claim 4, wherein the method further comprises:
pairing, by the vending machine, the child wearable device with an external computing device; and
transmitting a notification about the child wearable device to the external computing device.

7. The method of claim 6, wherein the notification is about the child wearable device breaching a predefined perimeter from the vending machine.

8. The method of claim 4, wherein the dispensing of the child wearable device by the vending machine results in activation of the child wearable device.

9. A vending machine for dispensing snack items for children and providing child security, the vending machine comprising:
a plurality of compartments;
one or more child wearable devices stored in one or more of the plurality of compartments, wherein each of the child wearable device is configured to be activated by the vending machine, wherein the child wearable device is configured to be worn by a child, wherein, upon activation, the child wearable device is configured to be coupled to the vending machine through a wireless connection; and
a control unit configured for tracking a distance of the child wearable device from the vending machine and generating an alert when the child wearable device breaches a predefined perimeter from the vending machine.

10. The vending machine of claim 9, wherein the one or more of the plurality of compartments are configured to store snack items, wherein the vending machine comprises a conveying unit to deliver the snack items to a pickup door of the vending machine.

11. The vending machine of claim 10, wherein the conveying unit is configured to deliver the child wearable device from the respective compartment to the pickup door.

12. The vending machine of claim 10, wherein the control unit is configured to implement an interface for interacting with a user, wherein the user can select a desired snack item or the child wearable device through the interface.

13. The vending machine of claim 12, wherein the child wearable device is a hand band that is configured to be worn on a hand of a child.

14. The vending machine of claim 12, wherein the control unit is configured for:
pairing the child wearable device with an external computing device; and
transmitting a notification about the child wearable device to the external computing device.

15. The vending machine of claim 14, wherein the notification is about the child wearable device breaching a predefined perimeter from the vending machine.

16. The vending machine of claim 14, wherein the dispensing of the child wearable device by the vending machine results in activation of the child wearable device.
